(19) United States
(12) Patent Application Publication
(10) Pub. No.: US 2025/0322503 A1
(43) Pub. Date: Oct. 16, 2025

(54) IMAGE INSPECTION APPARATUS

(71) Applicant: Keyence Corporation, Osaka (JP)

(72) Inventor: Xinliang ZHAO, Osaka (JP)

(73) Assignee: Keyence Corporation, Osaka (JP)

(21) Appl. No.: 19/066,209

(22) Filed: Feb. 28, 2025

(30) Foreign Application Priority Data
Apr. 12, 2024 (JP) 2024-064815
Dec. 5, 2024 (JP) 2024-212049

(51) Int. Cl. G06T 7/00; G06V 10/22; G06V 10/82

(52) U.S. Cl. CPC G06T 7/0002; G06V 10/235; G06V 10/82

(57) ABSTRACT

An image inspection apparatus includes a control unit configured to execute a model which is a segmentation model. The model includes an encoder part configured to extract a first feature from the inspection image data, a connection part configured to receive a second feature different from the first feature from at least one of layers in the encoder part, convert the second feature into a third feature, and supply the third feature, and a decoder part configured to upsample the first feature using the third feature. The control unit updates the parameters of the connection part and the parameters of the decoder part when executing machine learning of the model based on the training image data.

### CROSS-REFERENCE TO RELATED APPLICATIONS

The present application claims foreign priority based on Japanese Patent Application No. 2024-064815, filed Apr. 12, 2024 and No. 2024-212049, filed Dec. 5, 2024, the contents of which are incorporated herein by references.

### BACKGROUND OF THE INVENTION

### 1. Technical Field

This invention relates to an image inspection apparatus.

### 2. Description of the Related Art

An apparatus that trains a machine learning model to extract defective areas of defective products using non-defective product images at the production site of the work.

For example, JP2023-077054A discloses such apparatus.

In order to improve the accuracy of the boundary of the defective area, it is conceivable to use U-Net disclosed in Olaf Ronneberger, Philipp Fischer, and Thomas Brox: “U-Net: Convolutional Networks for Biomedical Image Segmentation” retrieved from the Internet: URL: https://arxiv.org/pdf/1505.04597.pdf, which is an example of a segmentation model that classifies image data at the pixel level, instead of the machine learning model disclosed in JP2023-077054A.

### SUMMARY OF THE INVENTION

However, U-Net requires a large computational cost for learning the encoder part that constitutes the model, making it difficult to learn on equipment (such as CPU [central processing unit]) with relatively low processing capability.

Therefore, U-Net is difficult to learn in the production site of the work. It should be noted that being difficult to learn includes cases where learning takes a very long time.

The present disclosure is directed to providing an image inspection apparatus that performs inspection of inspection image data using a model capable of reducing the computational cost required for learning in the production site of the work.

According to one embodiment, an image inspection apparatus configured to inspect inspection image data using a model in which parameters are updated by machine learning based on training image data presented by a user. The image inspection apparatus includes an imaging unit, a control unit configured to execute the model to which the inspection image data obtained by imaging by the imaging unit is input, The model outputs image data indicating a region belonging to a first class and a region not belonging to the first class in the input inspection image data based on a label indicating the first class assigned to the training image data, so that the region belonging to the first class and the region not belonging to the first class are distinguishable. And the model includes an encoder part configured to extract a first feature from the inspection image data, including a plurality of intermediate layers including convolutional layers, an encoder part that extracts a first feature from the inspection image data, a connection part configured to receive a second feature different from the first feature from at least one of the plurality of intermediate layers, convert the second feature into a third feature, and supply the third feature, a decoder part configured to upsample the first feature extracted by the encoder part using the third feature supplied by the connection part. The control unit updates the parameters of the connection part and the parameters of the decoder part when executing the machine learning of the model based on the training image data.

In addition, other features, elements, steps, advantages, and characteristics will be further clarified by the forms for implementing the invention that follow and the accompanying drawings related thereto.

According to the present disclosure, it is possible to provide an image inspection apparatus that performs inspection of inspection image data using a model that can reduce the computational cost required for learning in the production site of the work.

### BRIEF DESCRIPTION OF THE DRAWINGS

FIG. 1 is a schematic diagram showing the configuration of the appearance inspection apparatus according to an embodiment of the present invention.

FIG. 2 is a block diagram showing the hardware configuration (controller type) of the appearance inspection apparatus.

FIG. 3 is a diagram showing the input/output processing in the learning stage and the operation stage, respectively.

FIG. 4 is a diagram showing the outline configuration of the machine learning model.

FIG. 5 is a diagram showing a structural example of the encoder part.

FIG. 6 is a diagram showing a structural example of the connection part.

FIG. 7 is a diagram showing a structural example of the decoder part.

FIG. 8 is a diagram showing the outline flow of the annotation processing.

FIG. 9 is a diagram showing the display screen of the display device.

FIG. 10 is a diagram showing the display screen of the display device.

FIG. 11 is a diagram showing the display screen of the display device.

FIG. 12 is a diagram showing the display screen of the display device.

FIG. 13 is a diagram showing the outline flow of the inspection result display process.

FIG. 14 is a diagram showing the display screen of the display device.

FIG. 15 is a diagram showing the outline flow of the simplified annotation processing.

FIG. 16 is a diagram showing an example of a non-defective product image.

FIG. 17 is a diagram showing an example of a defective product image.

FIG. 18 is a diagram showing the display screen of the display device.

FIG. 19 is a diagram showing the display screen of the display device.

FIG. 20 is a diagram showing the display screen of the display device.

FIG. 21 is a block diagram showing another hardware configuration (smart camera type) of the appearance inspection apparatus.

FIG. 22 is a diagram showing the usage form of the removable memory in the smart camera type appearance inspection apparatus.

### DETAILED DESCRIPTION

The following describes in detail the embodiments of the present invention based on the drawings. The description of the preferred embodiments below is essentially illustrative and is not intended to limit the present invention, its applications, or its uses.

### (Structure of Appearance Inspection Apparatus 1)

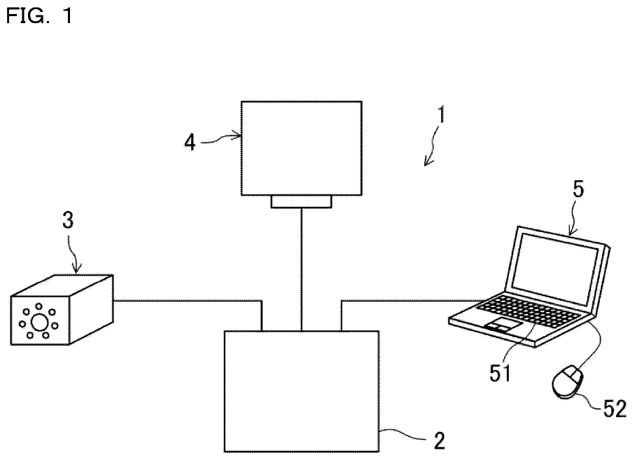

FIG. 1 is a schematic diagram showing the structure of the appearance inspection apparatus 1 according to an embodiment of the present invention. The appearance inspection apparatus 1 is a device that performs pass/fail judgment on work images obtained by capturing a work, which is an inspection target such as various parts or products, and outputs the results of the pass/fail judgment to an external device (not shown) connected to the external inspection apparatus 1, and can be used in production sites such as factories. Specifically, a machine learning network is constructed inside the appearance inspection apparatus 1, and this machine learning network is generated by learning at least one of non-defective product images corresponding to non-defective products and defective product images corresponding to defective products. The generated machine learning network allows inputting the work image captured of the inspection target work and performing the pass/fail judgment of the work image by the machine learning network. It should be understood that the appearance inspection apparatus 1 is an aspect of an image inspection apparatus.

The work may be the entire inspection target, or only a part of the work may be the inspection target. Furthermore, multiple inspection targets may be included in one work. Additionally, the work image may include multiple works.

The appearance inspection apparatus 1 includes a control unit 2 that serves as the main body of the apparatus, an imaging unit 3, a display device (display unit) 4, and a personal computer 5. The personal computer 5 is not essential and can be omitted. Instead of the display device 4, the personal computer 5 can be used to display various information and images, or the functions of the personal computer 5 can be incorporated into the control unit 2 or the display device 4.

In FIG. 1, as an example of the configuration of the appearance inspection apparatus 1, the control unit 2, imaging unit 3, display device 4, and personal computer 5 are described, and any combination of multiple of these can be integrated. For example, the control unit 2 and imaging unit 3 can be integrated, or the control unit 2 and display device 4 can be integrated. Furthermore, the control unit 2 can be divided into multiple units, with part incorporated into the imaging unit 3 or display device 4, or the imaging unit 3 can be divided into multiple units, with part incorporated into other units.

### (Configuration of Imaging Unit 3)

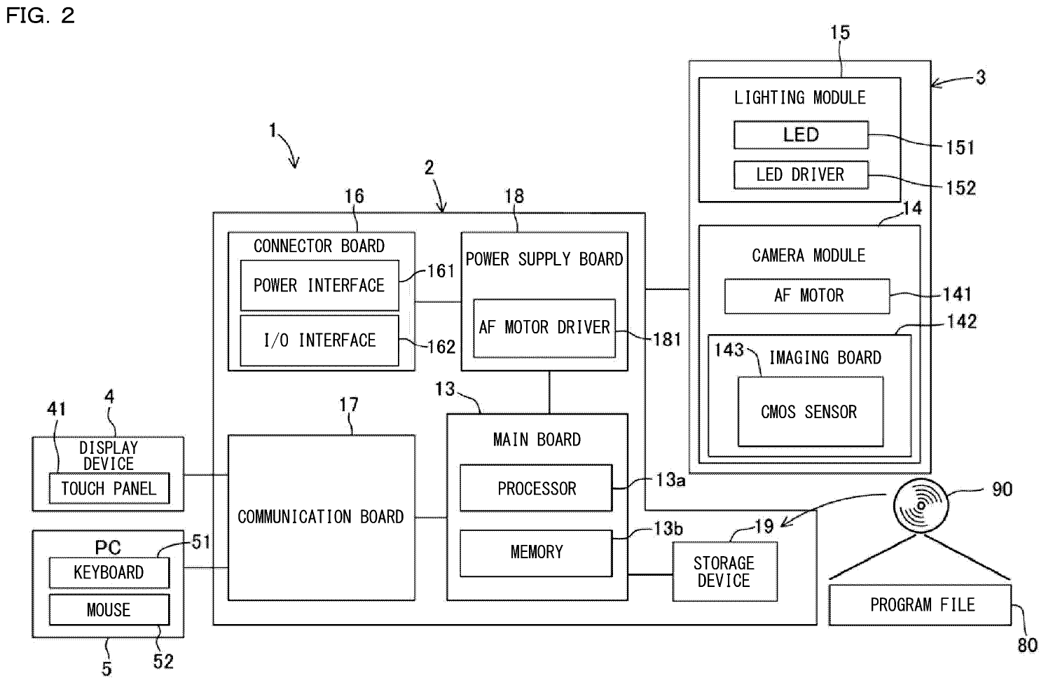

As shown in FIG. 2, the imaging unit 3 is equipped with a camera module (imaging unit) 14 and a lighting module (lighting unit) 15, and is a unit that performs the acquisition of work images. The camera module 14 includes an AF (auto focus) motor 141 that drives the imaging optical system and an imaging board 142. The AF motor 141 is a part that automatically performs focus adjustment by driving the lens of the imaging optical system, and can perform focus adjustment using methods such as the well-known contrast autofocus. The imaging board 142 is equipped with a CMOS (complementary metal oxide semiconductor) sensor 143 as a light-receiving element that receives light incident from the imaging optical system. The CMOS sensor 143 is an imaging sensor configured to acquire color images. Instead of the CMOS sensor 143, a light-receiving element such as a CCD (charge coupled device) sensor can also be used.

The lighting module 15 includes an LED (light-emitting diode) 151 as a light-emitting element that illuminates an imaging area including a workpiece, and an LED driver 152 that controls the LED 151. The light emission timing, light emission duration, and light emission amount of the LED 151 can be arbitrarily controlled by the LED driver 152. The LED 151 may be integrally provided with the imaging unit 3 or may be provided as an external lighting unit separately from the imaging unit 3.

### (Structure of Display Device 4)

The display device 4 has a display panel made of, for example, a liquid crystal panel or an organic EL (electro luminescence) panel. The work image and user interface image output from the control unit 2 are displayed on the display device 4. In addition, if the personal computer 5 has a display panel, the display panel of the personal computer 5 can be used instead of the display device 4.

### (Operation Device)

As an operation device for the user to operate the appearance inspection apparatus 1, for example, a keyboard 51 or a mouse 52 possessed by a personal computer 5 can be mentioned, but it is not limited to these, and any device configured to accept various operations by the user is acceptable.

For example, a pointing device such as a touch panel 41 possessed by the display device 4 is also included as an operation device.

The operations by the user using the keyboard 51 and the mouse 52 can be detected by the control unit 2. In addition, the touch panel 41 is a conventionally known touch-type operation panel equipped with, for example, a pressure-sensitive sensor, and the user's touch operation can be detected by the control unit 2. The same applies when using other pointing devices.

### (Structure of Control Unit 2)

The control unit 2 includes a main board 13, a connector board 16, a communication board 17, and a power supply board 18. The main board 13 is provided with a processor 13a. The processor 13a controls the operation of each board and module connected to it. For example, the processor 13a outputs a lighting control signal that controls the lighting and extinguishing of LED 151 to the LED driver 152 of the lighting module 15. The LED driver 152 switches the lighting and extinguishing of LED 151 and adjusts the lighting time in accordance with the lighting control signal from the processor 13a, as well as adjusts the light amount of LED 151.

The processor 13a outputs an imaging control signal to control the CMOS sensor 143 on the imaging board 142 of the camera module 14. The CMOS sensor 143 starts imaging in response to the imaging control signal from the processor 13a and performs imaging by adjusting the exposure time to an arbitrary duration. That is, the imaging unit 3 captures the area within the field of view of the CMOS sensor 143 according to the imaging control signal output from the processor 13a, and if there is a workpiece within the field of view, it will capture the workpiece; however, if there are other objects within the field of view, those can also be captured. For example, the appearance inspection apparatus 1 can capture non-defective product images corresponding to non-defective products and defective product images corresponding to defective products as images for learning of the machine learning network using the imaging unit 3. The images for learning do not necessarily have to be images captured by the imaging unit 3; they can also be images captured by other cameras, etc.

On the other hand, during the operation of the appearance inspection apparatus 1, the imaging unit 3 can capture the workpiece. In addition, the CMOS sensor 143 is configured to output a live image, that is, the currently captured image, at a short frame rate at any time.

When the imaging by the CMOS sensor 143 is completed, the image signal output from the imaging unit 3 is input to the processor 13a of the main board 13 for processing, and is stored in the memory 13b of the main board 13. The details of the specific processing content by the processor 13a of the main board 13 will be described later. It is also possible that a processing device such as an FPGA or DSP is provided on the main board 13. The processor 13a may be an integrated processor that includes processing devices such as FPGA and DSP.

The connector board 16 is a part that receives power supply from the outside via a power connector (not shown) provided at the power interface 161. The power board 18 is a part that distributes the power received by the connector board 16 to each board and module, specifically distributing power to the lighting module 15, camera module 14, main board 13, and communication board 17. The power board 18 is equipped with an AF motor driver 181. The AF motor driver 181 supplies driving power to the AF motor 141 of the camera module 14, realizing autofocus. The AF motor driver 181 adjusts the power supplied to the AF motor 141 according to the AF control signal from the processor 13a of the main board 13. Additionally, the connector board 16 is a part that outputs inspection results to external devices via the I/O terminal provided at the I/O interface 162.

The communication board 17 is a part that executes communication between the main board 13 and the display device 4 and the personal computer 5, as well as communication between the main board 13 and external control devices (not shown). The external control device can include, for example, a programmable logic controller. The communication may be wired or wireless, and either communication form can be realized by a conventional well-known communication module.

The control unit 2 is provided with a storage device 19 composed of, for example, a solid state drive, a hard disk drive, and the like. The storage device 19 stores program files 80 and setting files (software) that enable the execution of the various controls and processes described later by the above hardware. The program files 80 and setting files can be stored on a storage medium 90 such as an optical disk, and the program files 80 and setting files stored on this storage medium 90 can be installed in the control unit 2. The program files 80 may also be downloaded from an external server using a communication line. In addition, the storage device 19 can also store, for example, the above image data and parameters for constructing the machine learning network of the appearance inspection apparatus 1.

That is, the processor 13a of the appearance inspection apparatus 1 is configured to read parameters stored in the storage device 19 to construct a machine learning network, input a work image captured of the work to be inspected into the constructed machine learning network, execute the constructed machine learning network, and perform a pass/fail judgment of the work based on the input work image. By using this appearance inspection apparatus 1, an appearance inspection method that performs a pass/fail judgment of the work based on the work image can be executed. The machine learning network may be understood as a machine learning model (a model in which parameters are updated through machine learning).

### (Input/Output Processing)

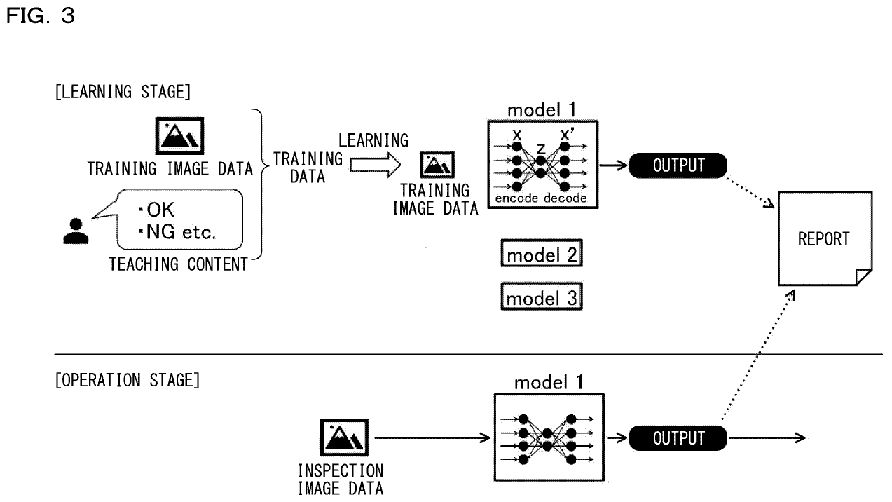

FIG. 3 is a diagram showing the input/output processing in the learning stage and the operation stage of the appearance inspection apparatus 1. As shown in this figure, in the learning stage of the appearance inspection apparatus 1, the machine learning model is trained based on the training data presented by the user (customer as seen from the vendor).

The training data includes training image data and teaching content. The training image data includes at least one of the image data of non-defective product image data and defective product image data. The teaching content includes labels indicating classes such as “this image data is a non-defective product,” “this image data is a defective product,” and “this part is anomaly.”

In the above learning, the parameters of the machine learning model are updated (adjusted) so that the output of the machine learning model approaches the expected value in accordance with the teaching content. The machine learning model may be prepared in multiple instances (model1 to model3). With such a configuration, it becomes possible to arbitrarily select the learning target or operation target according to the application of the appearance inspection apparatus 1.

The above learning does not necessarily require the user to perform all processes. For example, the vendor side may complete relatively high computational cost learning before the shipment of the appearance inspection apparatus 1, and the user side may only need to perform relatively low computational cost learning before the operation of the appearance inspection apparatus 1. In this specification, the learning conducted by the vendor side before shipment is referred to as pre-shipment learning, and the learning conducted by the user side before the operation of the appearance inspection apparatus 1 is referred to as on-site learning.

That is, the machine learning model of the appearance inspection apparatus 1 may include a parameter fixed part. The parameter fixed part refers to a layer in which parameters obtained from the vendor's pre-shipment training are fixed, in other words, a layer that does not require customer learning on the user side.

The machine learning model of the appearance inspection apparatus 1 includes a parameter-fixed part, which eliminates the need for the user to prepare high-performance equipment (such as GPU [graphics processing unit]) or for the vendor to provide an advanced learning environment via GPU as a cloud service (such as SaaS). Therefore, the introduction barrier of the appearance inspection apparatus 1 is lowered.

In this way, the above learning should be broadly interpreted as not only referring to learning with a large computational cost represented by deep learning, but also including learning with a small computational cost (on-site learning).

On the other hand, in the operation stage of the appearance inspection apparatus 1, inspection of the inspection image data is performed using a learned machine learning model. The inspection includes area division (Segmentation). In addition to area division, the inspection may also include image classification (Classification), anomaly detection, and so on.

In the area division of the image, classification is performed for each pixel forming the image, and areas are divided according to the classification. The appearance inspection apparatus 1 classifies the pixels forming the image as anomaly/normal in the image inspection for quality judgment, and determines the object (work) depicted in the image as a defective product when the area composed of the pixels classified as anomaly is equal to or greater than a certain area. In the classification of the image, classification is performed for each image or each area specified in the image. The appearance inspection apparatus 1 classifies the image depicting the object (work) in the image inspection for quality judgment into non-defective product images and defective product images, determining the object (work) depicted in the non-defective product image as non-defective and the object (work) depicted in the defective product image as defective. In the anomaly detection of the image, anomalous parts are extracted from the image. For example, anomaly detection using an autoencoder is well-known. The autoencoder can be understood as a machine learning model that is trained (parameter adjustment) to make the anomalous parts contained in the anomalous image stand out when normal and anomalous images are input. The appearance inspection apparatus 1 determines whether the image is a non-defective product image or a defective product image based on the degree of anomaly and area of the detected anomalies, thereby judging the quality of the object (work) depicted in the image.

Furthermore, the appearance inspection apparatus 1 is equipped with a report output unit (model evaluation result generation unit) that outputs a report display based on the output result of the machine learning model in the learning stage or operation stage. In other words, the target image data input to the machine learning model for the report display may be at least one of the training image data and the inspection image data.

The report output unit can be understood as a function of editor software executed on a personal computer 5, for example. In other words, the personal computer 5 functions as the report output unit by executing the editor software.

### (Segmentation Model)

The machine learning model model1 used in the appearance inspection apparatus 1 is a segmentation model that classifies image data at the pixel level. The machine learning model model1 outputs distinguishable image data for regions belonging to the first class (anomaly) based on the label indicating the first class assigned to the training image data, among the image regions of the input inspection image data that belong to the first class and those that do not belong to the first class.

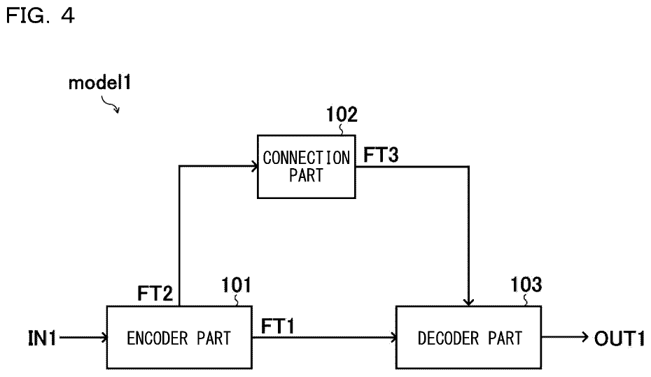

FIG. 4 is a diagram showing the schematic configuration of the machine learning model model1. The machine learning model model1 includes an encoder part 101, a connection part 102, and a decoder part 103.

The encoder part 101 is a neural network having a FCN [fully convolution network] structure, which includes multiple convolutional layers. The encoder part 101 inputs the input image data IN1. The encoder part 101 extracts the first feature FT1 from the input image data IN1. The encoder part 101 supplies the first feature FT1 to the decoder part 103. In the learning stage of the appearance inspection apparatus 1, the input image data IN1 is training image data. In the operation stage of the appearance inspection apparatus 1, the input image data IN1 is inspection image data.

The connection part 102 receives a second feature FT2 that is different from the first feature FT1 from at least one of the multiple convolutional layers included in the encoder part 101. As will be described later, the second feature FT2 has information that is not included in the first feature FT1 and is information that improves the processing accuracy in the decoder part 103. The connection part 102 converts the second feature FT2 into a third feature FT3. The connection part 102 supplies the third feature FT3 to the decoder part 103.

The decoder part 103 upsamples the first feature FT1 while using the third feature FT3. The decoder part 103 outputs the output image data OUT1 obtained by upsampling the first feature FT1. The output image data OUT1 has the same size (number of pixels in the width direction×number of pixels in the height direction) as the input image data IN1. The number of channels of the output image data OUT1 is 1, regardless of the number of channels of the input image data IN1.

The parameters of the encoder part 101 are fixed by pre-shipment training on the vendor side. On the other hand, the parameters of the connection part 102 and the parameters of the decoder part 103 are adjusted based on the training data presented by the user during the learning stage in the appearance inspection apparatus 1.

The parameters of the encoder part 101 are fixed by pre-shipment learning on the vendor side, as mentioned above. Therefore, the machine learning model model1 can reduce the computational cost required for learning based on the training data presented by the user (learning in the production site of the work). It should be noted that, within the range where the computational cost required for learning based on the training data presented by the user does not exceed the allowable upper limit, some parameters of the encoder part 101 may be adjusted based on the training data presented by the user.

And, as mentioned above, the connection part 102 does not supply the second feature FT2 directly to the decoder part 103, but converts the second feature FT2 into the third feature FT3 and supplies the third feature FT3 to the decoder part 103. By tuning the features (conversion from the second feature FT2 to the third feature FT3), the decoder part 103 can obtain features suitable for upsampling processing of features in the decoder part 103 as the features (third feature FT3) supplied from the connection part 102 to the decoder part 103. As mentioned above, the parameters of the connection part 102 are adjusted based on the training data presented by the user. Therefore, even if the parameters of the encoder part 101 are fixed by pre-shipment learning on the vendor side, a certain level of accuracy can be ensured in the inspection of inspection image data using the learned machine learning model model1. More specifically, when the parameters of the encoder part 101 are determined by pre-shipment learning on the vendor side, while the parameters of the decoder part 103 are adjusted by the training data presented by the user, the second feature FT2 supplied from the encoder part 101 may not be suitable for the adjusted decoder part 103. By adjusting the parameters of the connection part 102 according to the parameter adjustment of the decoder part 103, the connection part 102 can output the third feature FT3 suitable for the decoder part 103.

### (Structure Example of Encoder Part)

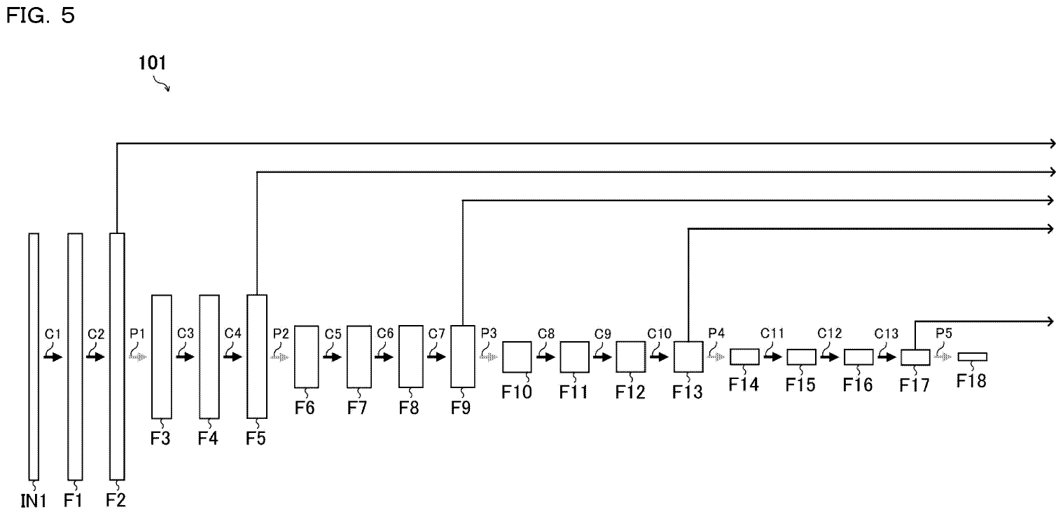

FIG. 5 is a diagram showing a structure example of the encoder part 101. The encoder part 101 shown in the structure example in FIG. 5 includes convolutional layers C1 to C13 and pooling layers P1 to P5. In each convolutional layer C1 to C13, after convolution processing, nonlinear transformation processing using an activation function is performed. The activation function is typically a ReLU function. However, the activation function is not limited to the ReLU function, and may be, for example, a sigmoid function, a softmax function, a Leaky ReLU function, a GELU function, or a hyperbolic tangent function. The pooling layer is typically a max pooling layer. However, the pooling layer is not limited to the max pooling layer, and may be, for example, an average pooling layer.

In FIG. 5, when the input image data IN1, which has a width direction data count of 224, a height direction data count of 224, and a channel count of 3 (corresponding to the three colors R, G, and B), is input to the encoder unit 101, the feature quantities F1 to F18 generated in the encoder unit 101 are illustrated. In the following explanation, the width direction data count is denoted as a, the height direction data count as b, and the channel count as c, which is expressed as [a×b]×c.

The convolutional layer C1 performs convolution processing and nonlinear transformation processing on the input image data IN1 of [224×224]×3, converting the input image data IN1 of [224×224]×3 into the feature quantity F1 of [224×224]×64. The feature quantity F1 of [224×224]×64 is supplied to the convolutional layer C2.

The convolutional layer C2 performs convolution processing and nonlinear transformation processing on the feature F1 of [224×224]×64, converting the feature F1 of [224×224]×64 into the feature F2 of [224×224]×64. The feature F2 of [224×224]×64 is supplied to the connection part 102 (refer to FIG. 4) and the pooling layer P1.

The pooling layer P1 performs pooling processing on the feature quantity F2 of [224×224]×64, converting the feature quantity F2 of [224×224]×64 into the feature quantity F3 of [112×112]×128. The feature quantity F3 of [112×112]×128 is supplied to the convolutional layer C3.

The convolutional layer C3 performs convolution processing and nonlinear transformation processing on the feature quantity F3 of [112×112]×128, converting the feature quantity F3 of [112×112]×128 into the feature quantity F4 of [112×112]×128. The feature quantity F4 of [112×112]×128 is supplied to the convolutional layer C4.

The convolutional layer C4 performs convolution processing and nonlinear transformation processing on the feature quantity F4 of [112×112]×128, converting the feature quantity F4 of [112×112]×128 into the feature quantity F5 of [112×112]×128. The feature quantity F5 of [112×112]×128 is supplied to the connection part 102 (refer to FIG. 4) and the pooling layer P2.

The pooling layer P2 performs pooling processing on the feature quantity F5 of [112×112]×128, converting the feature quantity F5 of [112×112]×128 into the feature quantity F6 of [56×56]×256. The feature quantity F6 of [56×56]×256 is supplied to the convolutional layer C5.

The convolutional layer C5 performs convolution processing and nonlinear transformation processing on the feature quantity F6 of [56×56]×256, converting the feature quantity F6 of [56×56]×256 into the feature quantity F7 of [56×56]×256. The feature quantity F7 of [56×56]×256 is supplied to the convolutional layer C6.

The convolutional layer C6 performs convolution processing and nonlinear transformation processing on the feature quantity F7 of [56×56]×256, converting the feature quantity F7 of [56×56]×256 into the feature quantity F8 of [56×56]×256. The feature quantity F8 of [56×56]×256 is supplied to the convolutional layer C7.

The convolutional layer C7 performs convolution processing and nonlinear transformation processing on the feature quantity F8 of [56×56]×256, converting the feature quantity F8 of [56×56]×256 into the feature quantity F9 of [56×56]×256. The feature quantity F9 of [56×56]×256 is supplied to the connection part 102 (refer to FIG. 4) and the pooling layer P3.

The pooling layer P3 performs pooling processing on the feature quantity F9 of [56×56]×256, converting the feature quantity F9 of [56×56]×256 into the feature quantity F10 of [28×28]×512. The feature quantity F10 of [28×28]×512 is supplied to the convolutional layer C8.

The convolutional layer C8 performs convolution processing and nonlinear transformation processing on the feature quantity F10 of [28×28]×512, converting the feature quantity F10 of [28×28]×512 into the feature quantity F11 of [28×28]×512. The feature quantity F11 of [28×28]×512 is supplied to the convolutional layer C9.

The convolutional layer C9 performs convolution processing and nonlinear transformation processing on the feature quantity F11 of [28×28]×512, converting the feature quantity F11 of [28×28]×512 into the feature quantity F12 of [28×28]×512. The feature quantity F12 of [28×28]×512 is supplied to the convolutional layer C10.

The convolution layer C10 performs convolution processing and nonlinear transformation processing on the feature quantity F12 of [28×28]×512, converting the feature quantity F12 of [28×28]×512 into the feature quantity F13 of [28×28]×512. The feature quantity F13 of [28×28]×512 is supplied to the connection part 102 (refer to FIG. 4) and the pooling layer P4.

The pooling layer P4 performs pooling processing on the feature quantity F13 of [28×28]×512, converting the feature quantity F13 of [28×28]×512 into the feature quantity F14 of [14×14]×512. The feature quantity F14 of [14×14]×512 is supplied to the convolutional layer C11.

The convolutional layer C11 performs convolution processing and nonlinear transformation processing on the feature quantity F14 of [14×14]×512, converting the feature quantity F14 of [14×14]×512 into the feature quantity F15 of [14×14]×512. The feature quantity F15 of [14×14]×512 is supplied to the convolutional layer C12.

The convolutional layer C12 performs convolution processing and nonlinear transformation processing on the feature quantity F15 of [14×14]×512, converting the feature quantity F15 of [14×14]×512 into the feature quantity F16 of [14×14]×512. The feature quantity F16 of [14×14]×512 is supplied to the convolutional layer C13.

The convolutional layer C13 performs convolution processing and nonlinear transformation processing on the feature quantity F16 of [14×14]×512, converting the feature quantity F16 of [14×14]×512 into the feature quantity F17 of [14×14]×512. The feature quantity F17 of [14×14]×512 is supplied to the decoder part 103 (see FIG. 4) and the pooling layer P5.

The pooling layer P4 performs pooling processing on the feature F17 of [14×14]×512, converting the feature F17 of [14×14]×512 into the feature F18 of [7×7]×512. In this embodiment, the feature F17 is supplied to the decoder unit 103, but it may also be a configuration in which the feature F18 is supplied. Furthermore, it may also be a configuration in which a feature obtained from any layer included in the encoder unit 101 is supplied to the decoder unit 103.

The feature F17 of [14×14]×512 is the first feature FT1 mentioned earlier. The feature F2 of [224×224]×64, the feature F5 of [112×112]×128, the feature F9 of [56×56]×256, and the feature F13 of [28×28]×512 are respectively the aforementioned second feature FT2. Note that the number of the second feature FT2 is not limited to four, and at least one is sufficient.

The smaller the size of the feature, the less spatial information it contains, so the second feature FT2, which has a larger size than the first feature FT1, has spatial information that is not included in the first feature FT1.

### (Structure Example of Connection Part)

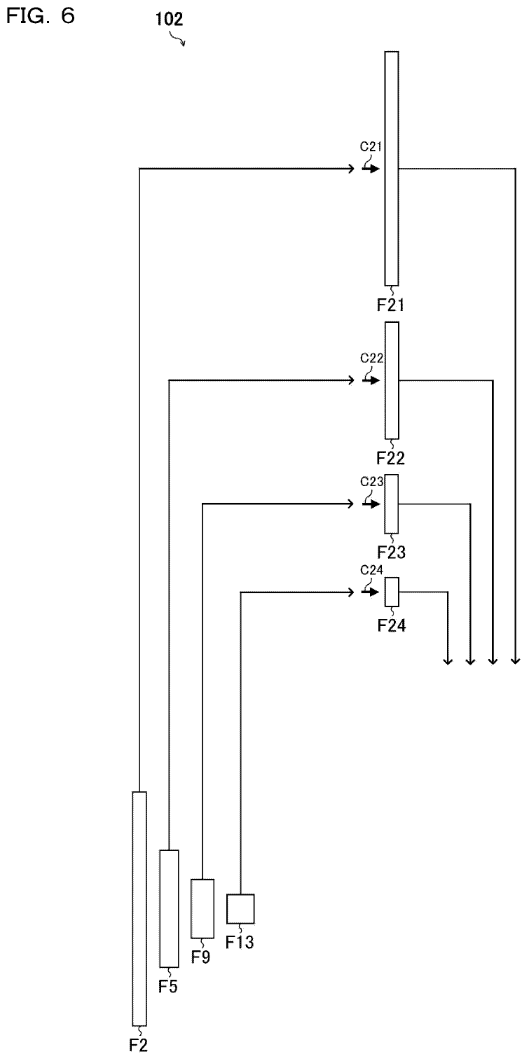

FIG. 6 is a diagram showing a structure example of connection part 102. The connection part 102 in the structure example shown in FIG. 6 includes convolution layers C21 to C24. Convolution processing is performed in each convolution layer C21 to C24.

The convolutional layer C21 performs convolution processing on the feature quantity F2 of [224×224]×64, converting the feature quantity F2 of [224×224]×64 into the feature quantity F21 of [224×224]×64. The feature quantity F21 of [224×224]×64 is supplied to the decoder part 103 (refer to FIG. 4).

The convolutional layer C22 performs convolution processing on the feature F5 of [112×112]×128, converting the feature F5 of [112×112]×128 into the feature F22 of [112×112]×64. The feature F22 of [112×112]×64 is supplied to the decoder part 103 (refer to FIG. 4).

The convolutional layer C23 performs convolution processing on the feature quantity F9 of [56×56]×256, converting the feature quantity F9 of [56×56]×256 into the feature quantity F23 of [56×56]×64. The feature quantity F23 of [56×56]×64 is supplied to the decoder part 103 (see FIG. 4).

The convolutional layer C24 performs convolution processing on the feature quantity F13 of [28×28]×512, converting the feature quantity F13 of [28×28]×512 into the feature quantity F24 of [28×28]×64. The feature quantity F24 of [28×28]×64 is supplied to the decoder part 103 (refer to FIG. 4).

The feature quantity F21 of [224×224]×64, the feature quantity F22 of [112×112]×64, the feature quantity F23 of [56×56]×64, and the feature quantity F24 of [28×28]×64 are respectively the aforementioned third feature FT3. The number of the third feature FT3 is not limited to four, and at least one is sufficient. However, the second feature FT2 and the third feature FT3 have the same number.

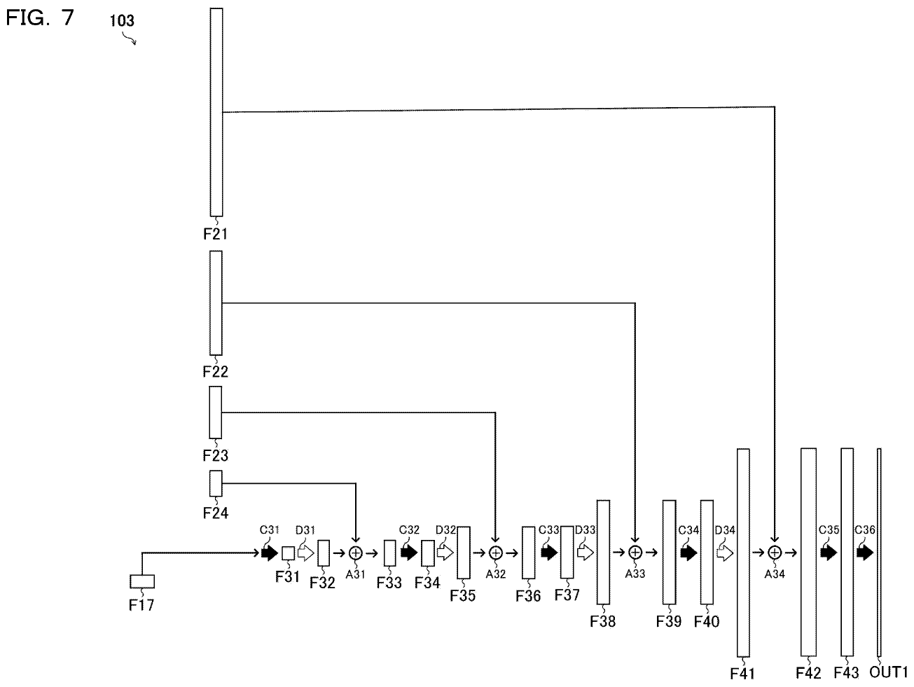

FIG. 7 is a diagram showing a structure example of the decoder part 103. The decoder part 103 shown in FIG. 7 includes convolution layers C31 to C36, deconvolutional layers D31 to D34, and concatenation layers A31 to A34. Convolution processing is performed in each convolution layer C31 to C36. In the deconvolutional layers D31 to D34, deconvolution processing (the reverse process of convolution) is performed. Instead of the deconvolutional layers, a layer that combines upsampling processing and convolution processing may be used. The concatenation layers A31 to A34 may be omitted.

The convolutional layer C31 performs convolution processing on the feature quantity F17 of [14×14]×512, converting the feature quantity F17 of [14×14]×512 into the feature quantity F31 of [14×14]×64. The feature quantity F31 of [14×14]×64 is supplied to the deconvolutional layer D31.

The deconvolutional layer D31 performs deconvolution processing on the feature F31 of [14×14]×64, converting the feature F31 of [14×14]×64 into the feature F32 of [28×28]×64. The feature F32 of [28×28]×64 is supplied to the concatenation layer A31.

The concatenation layer A31 adds the feature F24 of size [28×28]×64 to the feature F32 of size [28×28]×64, converting the feature F32 of size [28×28]×64 into the feature F33 of size [28×28]×64. The feature F33 of size [28×28]×64 is supplied to the convolutional layer C32.

The aforementioned addition is an example of a combining process, which refers to the process of adding together corresponding data of two feature quantities (data at the same width direction position, the same height direction position, and the same channel direction position). In the two feature quantities to be added, the width direction size, height direction size, and number of channels are each identical.

As another example of the combining process, there is concatenation. Concatenation refers to the process of aligning the width direction position and height direction position of two feature quantities and arranging the two feature quantities along the channel direction. In the two feature quantities to be concatenated, the width direction size and height direction size are the same for each other, and the number of channels may be the same or may be different from each other.

By adopting addition instead of concatenation as the combining process, it is possible to suppress the number of channels of the feature quantities supplied to the layer provided after the concatenation layer, thereby reducing the computational cost in the layer provided after the concatenation layer. Furthermore, by adopting concatenation as the combining process, it becomes possible to process feature quantities having different numbers of channels, which improves design flexibility.

The convolutional layer C32 performs convolution processing on the feature quantity F33 of [28×28]×64, converting the feature quantity F33 of [28×28]×64 into the feature quantity F34 of [28×28]×64. The feature quantity F34 of [28×28]×64 is supplied to the deconvolutional layer D32.

The deconvolutional layer D32 performs deconvolution processing on the feature F34 of [28×28]×64, converting the feature F34 of [28×28]×64 into the feature F35 of [56×56]×64. The feature F35 of [56×56]×64 is supplied to the concatenation layer A32.

The concatenation layer A32 adds the feature F23 of size [56×56]×64 to the feature F35 of size [56×56]×64, converting the feature F35 of size [56×56]×64 into the feature F36 of size [56×56]×64. The feature F36 of size [56×56]×64 is supplied to the convolutional layer C33.

The convolutional layer C33 performs convolution processing on the feature quantity F36 of [56×56]×64, converting the feature quantity F36 of [56×56]×64 into the feature quantity F37 of [56×56]×64. The feature quantity F37 of [56×56]×64 is supplied to the deconvolutional layer D33.

The deconvolutional layer D33 performs deconvolution processing on the feature F37 of [56×56]×64, converting the feature F37 of [56×56]×64 into the feature F38 of [112×112]×64. The feature F38 of [112×112]×64 is supplied to the concatenation layer A33.

The concatenation layer A33 adds the feature F22 of size [112×112]×64 to the feature F38 of size [112×112]×64, converting the feature F38 of size [112×112]×64 into the feature F39 of size [112×112]×64. The feature F39 of size [112×112]×64 is supplied to the convolutional layer C34.

The convolutional layer C34 performs convolution processing on the feature F39 of [112×112]×64, converting the feature F39 of [112×112]×64 into the feature F40 of [112×112]×64. The feature F40 of [112×112]×64 is supplied to the deconvolutional layer D34.

The deconvolutional layer D34 performs deconvolution processing on the feature quantity F40 of [112×112]×64, converting the feature quantity F40 of [112×112]×64 into the feature quantity F41 of [224×224]×64. The feature quantity F41 of [224×224]×64 is supplied to the concatenation layer A34.

The concatenation layer A34 adds the feature F21 of [224×224]×64 to the feature F41 of [224×224]×64, converting the feature F41 of [224×224]×64 into the feature F42 of [224×224]×64. The feature F42 of [224×224]×64 is supplied to the convolution layer C35.

The convolutional layer C35 performs convolution processing on the feature quantity F42 of [224×224]×64, converting the feature quantity F42 of [224×224]×64 into the feature quantity F43 of [224×224]×64. The feature quantity F43 of [224×224]×64 is supplied to the convolutional layer C36.

The convolutional layer C36 performs convolution processing on the feature F43 of [224×224]×64, converting the feature F43 of [224×224]×64 into the output image data OUT1.

### (Dimension of Input Image Data)

The input image data IN1 may be image data obtained from a single imaging, or may be a compilation of image data obtained from multiple imageries.

If the input image data IN1 is image data obtained by a single imaging, the input image data IN1 becomes three-dimensional image data, and each feature generated by the encoder part 101, the connection part 102, and the decoder part 103 becomes three-dimensional features, and the output image data OUT1 becomes three-dimensional image data.

If the input image data IN1 is a compilation of image data obtained by multiple captures, the input image data IN1 becomes four-dimensional image data, and each feature generated by the encoder part 101, connection part 102, and decoder part 103 becomes four-dimensional features, and the output image data OUT1 becomes four-dimensional image data.

### (Annotation)

The processor 13a performs annotation processing for the machine learning model model1 on the training image data, which is image data of defective products, to generate training data for the machine learning model model1. The training image data may be image data captured by the camera module 14, or it may be image data captured by an imaging unit other than the camera module 14 and stored in the storage device 19.

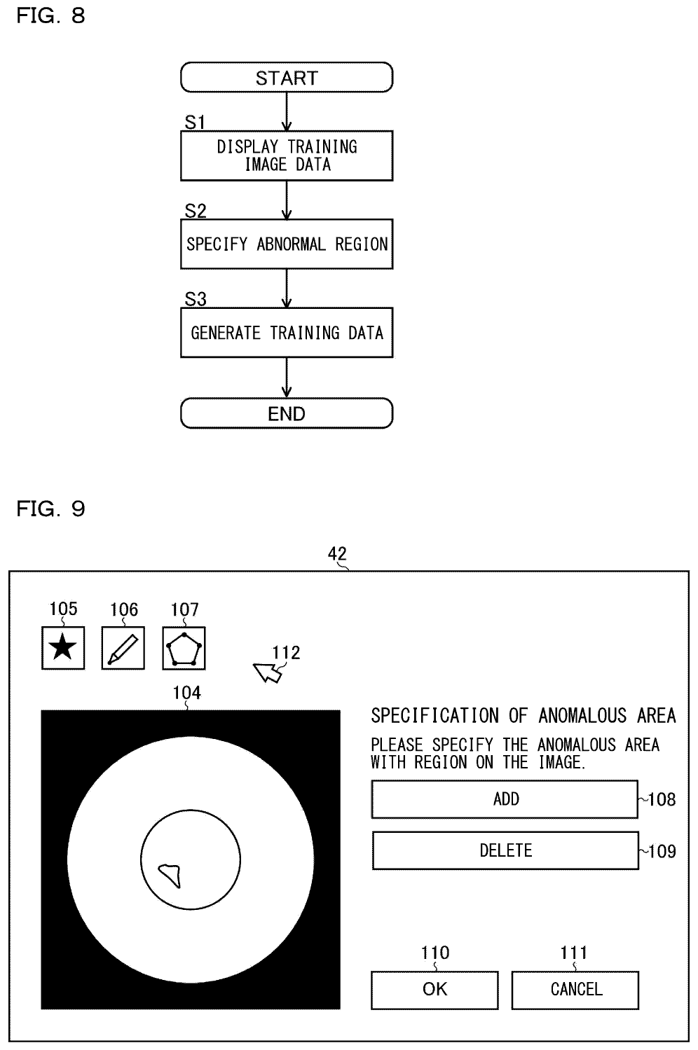

FIG. 8 is a diagram showing an outline flow of annotation processing for the machine learning model model1. When the training image data to be annotated is selected by user operation on the keyboard 51 or mouse 52, the flow shown in FIG. 8 is initiated.

In step S1, the processor 13a displays an image (training image) based on the training image data for annotation target on the display device 4. At this time, as shown in FIG. 9, the display screen 42 of the display device 4 displays the training image 104 along with icons 105 to 107 for annotation processing, an add button 108, a delete button 109, an OK button 110, a cancel button 111, a pointer 112, and a message.

In step S2 following step S1, the processor 13a specifies the anomalous region. The pointer 112 can be moved to any position on the display screen 42 by user operation with the mouse 52. When the pointer 112 overlaps with a specific icon or button and a user click operation is performed on the mouse 52, the specific icon or button is selected. It is also acceptable for one of the icons 105 to 107 to be selected by default from the beginning.

When the add button 108 is selected, it becomes possible to specify one anomalous region. When the delete button 109 is selected, it becomes possible to delete the mistakenly specified anomalous region by selecting the mistakenly specified abnormal region. When the OK button 110 is selected, the specification process in step S2 is completed, and the process proceeds to step S3. When the cancel button 111 is selected, the specification process in step S2 is invalidated, and without proceeding to the process of step S3, the flow shown in FIG. 8 is forcibly terminated.

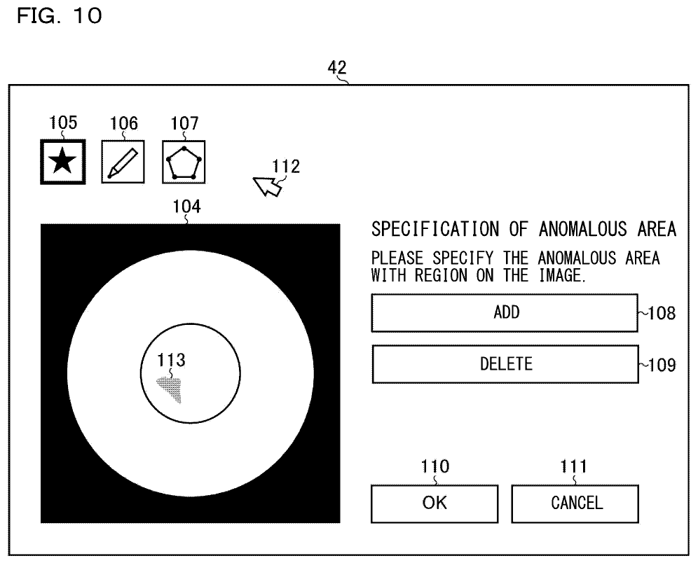

When the icon 105 shown in FIG. 10 is selected, the processor 13a specifies the anomalous region in the training image 104 with a free-form paint image 113 that is formed in accordance with user operation (user's drag operation on the mouse 52).

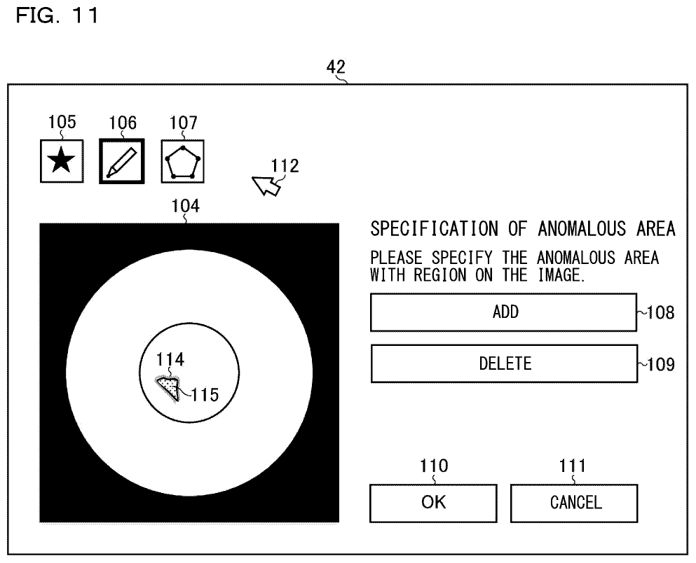

When the icon 106 is selected as shown in FIG. 11, the processor 13a specifies the anomalous region in the area 115, where the free curve 114 formed in response to user operation (user's drag operation on the mouse 52) serves as the boundary against the training image 104. If the free curve 114 is closed, the area surrounded by the free curve 114 becomes the area 115. If the free curve 114 is open, the area surrounded by the free curve 114 and the line segment connecting the starting point and the end point of the free curve 114 becomes the area 115.

An icon may be provided for specifying a region where a geometric curve formed in accordance with user operation for the anomalous region with respect to the training image 104 serves as a boundary, instead of or in addition to the icon 106. Similarly, an icon may be provided for specifying a region where a Bezier curve formed in accordance with user operation for the anomalous region with respect to the training image 104 serves as a boundary, instead of or in addition to the icon 106.

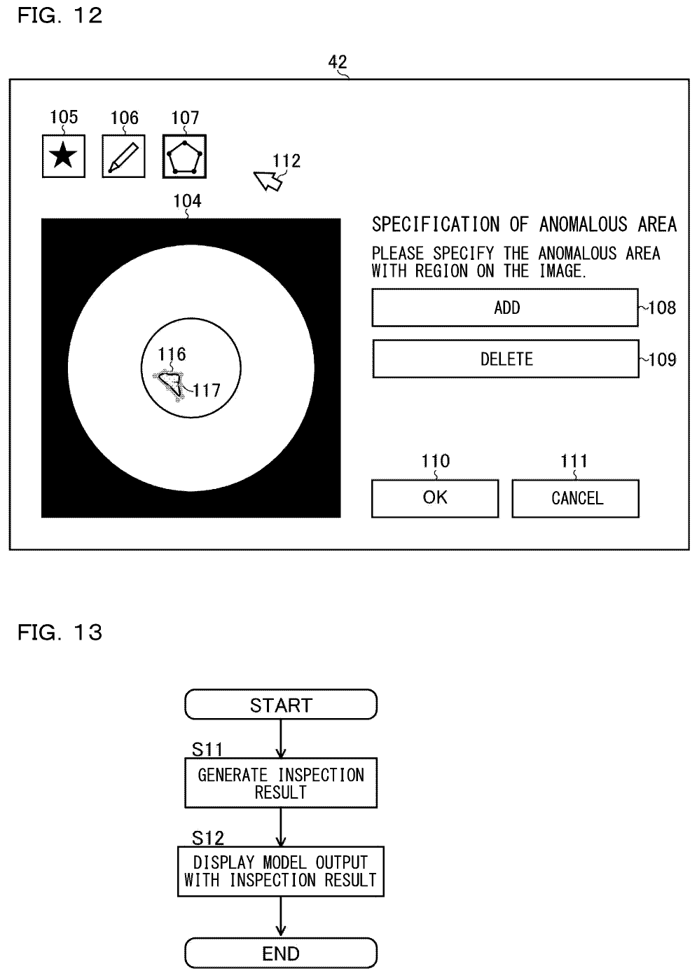

As shown in FIG. 12, when the icon 107 is selected, the processor 13a specifies the anomalous region in the area 117, where the polyline 116 formed in response to user operation (user's click operation on the mouse 52) serves as the boundary, with respect to the training image 104. If the polyline 116 is closed, the area surrounded by the polyline 116 becomes the area 117. If the polyline 116 is open, the area surrounded by the polyline 116 and the line segment connecting the starting point and the end point of the polyline 116 becomes the area 117.

As mentioned above, by specifying the anomalous region in the training image 104 with a line formed in accordance with user operation as the boundary area or with a free-form paint image formed in accordance with user operation, more precise annotation is possible than when specified with a predetermined shape such as a rectangle. Since the machine learning model model1 is a segmentation model that classifies image data at the pixel level, precise annotation is particularly useful.

In step S3, the processor 13a generates training data by adding the instruction content (teaching content) from step S2 as metadata to the training image data, and stores the generated training data in the storage device 19. When the processing of step S3 is completed, the flow shown in FIG. 8 ends.

### (Display of Inspection Results)

In the operation stage of the appearance inspection apparatus 1, the appearance inspection apparatus 1 performs area division (Segmentation) inspection of the inspection image data using the learned machine learning model model1. FIG. 13 is a diagram showing the outline flow of the inspection result display process that displays the results of the area division (Segmentation) inspection of the inspection image data. The inspection image data is input as input image data IN1 into the learned machine learning model model1, and when the output image data OUT1 is output from the learned machine learning model model1, completing the area division (Segmentation) inspection of the inspection image data, the flow shown in FIG. 13 begins.

In step S11, processor 13a generates the inspection result of the inspection image data based on output image data OUT1. For example, the inspection result of the inspection image data based on output image data OUT1 can be set to “NG” if the number of pixels in the anomalous area of output image data OUT1 is equal to or greater than the threshold, and “OK” if the number of pixels in the anomalous area of output image data OUT1 is less than the threshold.

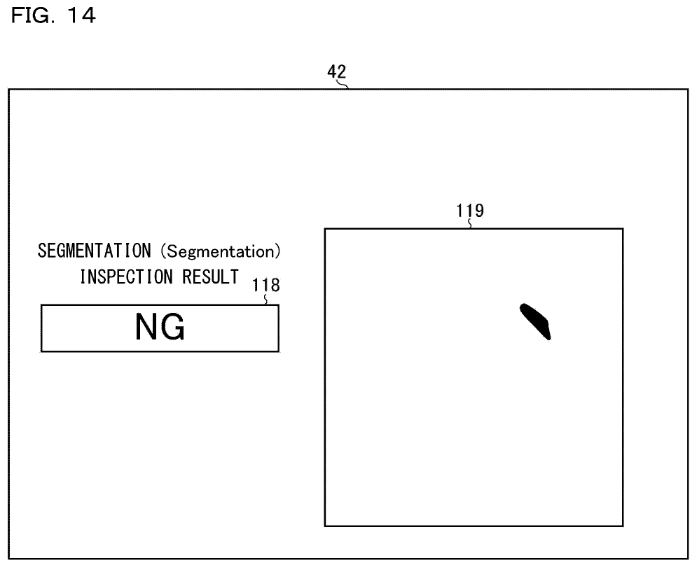

In step S12 following step S11, the processor 13a displays the output image data OUT1 along with the inspection result generated in step S11 on the display device 4. At this time, as shown in FIG. 14, the display screen 42 of the display device 4 displays the inspection result 118 generated in step S11 along with an image 119 based on the output image data OUT1. The black region of the image 119 based on the output image data OUT1 is the anomalous region, and the non-black region of the image 119 based on the output image data OUT1 is the non-anomalous region. When the processing of step S12 is completed, the flow shown in FIG. 13 ends.

The inspection of the appearance inspection apparatus 1 is a substitute for inspections that were originally performed visually by humans. Therefore, if there is a discrepancy between the inspection result from the appearance inspection apparatus 1 (“OK” or “NG”) and the inspection result from human visual inspection (“OK” or “NG”), it is preferable to be able to immediately confirm the image 119 based on the output image data OUT1, which is the cause of the discrepancy. Thus, as in the display process in step S12, it is preferable that the image 119 based on the output image data OUT1 is displayed together with the inspection result 118 generated in step S11. In other words, it is preferable that the inspection result 118 generated in step S11 and the image 119 based on the output image data OUT1 are displayed on a single screen.

As mentioned earlier, the connection part 102 converts the second feature FT2 into the third feature FT3, and by supplying the third feature FT3 to the decoder part 103, it is possible to ensure a certain level of accuracy in the inspection of inspection image data using the learned machine learning model model1. Therefore, the appearance inspection apparatus 1 can reduce the occurrence of discrepancies between the inspection results of the appearance inspection apparatus 1 and the inspection results obtained by human visual inspection.

### (Simple Annotation)

In the aforementioned annotation processing, ideally, the user is required to specify all of the anomalous regions. In the aforementioned annotation processing, the greater the omission of specifying the anomalous regions, the lower the accuracy of the annotation. However, forcing the user to perform annotation work with few omissions in specifying the anomalous regions, that is, precise annotation work, increases the difficulty of user operation.

Therefore, it is desirable to equip the appearance inspection apparatus 1 with a function that outputs detection results closer to the actual defective areas than the user's rough specification, even if the user roughly specifies the anomalous region (a function that performs simplified annotation processing). By equipping the appearance inspection apparatus 1 with the function to perform simplified annotation processing, user operations on the appearance inspection apparatus 1 become easier.

Conventionally, a simplified annotation processing disclosed in Research Institute of Systems Planning, Inc. “gLupe”, retrieved from the Internet: URL: https://glupe.jp/glupe/index.php?utm_source=bing&utm_medium=cpc&msclkid=ba67502dfd3cldc02ec5372a8db534be is known. However, the simplified annotation processing disclosed in it has the problem that not only a rough specification of the anomalous region is required, but also a rough specification of regions other than the anomalous region is necessary.

This disclosure describes a simplified annotation processing that can solve the problem, namely, a simplified annotation processing that does not require a rough specification of regions other than the anomalous region.

The processor 13a accepts a simple annotation specifying a part of the defective area (anomalous area) of the defective product image and a non-defective product image, performs simple annotation processing for the machine learning model model1, and generates training data for the machine learning model model1. The data of the defective product image and the data of the non-defective product image may be imaging data captured by the camera module 14, or imaging data captured by an imaging unit other than the camera module 14 and stored in the storage device 19.

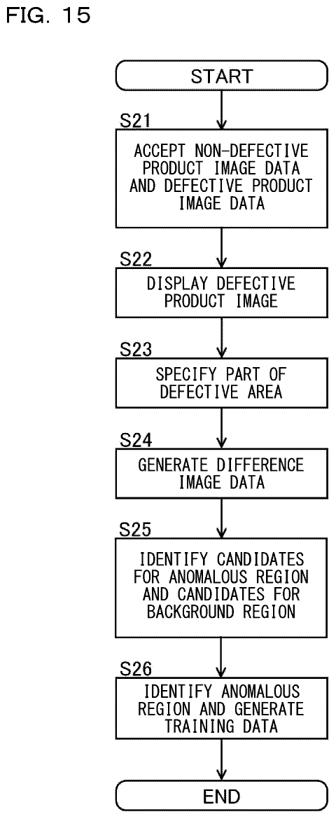

The processor 13a can display an annotation processing icon for starting the aforementioned annotation processing and an annotation processing icon for starting the simplified annotation processing on the display screen 42 of the display device 4. When the annotation processing icon is selected by a user operation on the keyboard 51 or mouse 52, and further, the training image data (defective product image data) to be annotated is selected, the flow shown in the aforementioned FIG. 8 is started. On the other hand, when the simplified annotation processing icon is selected by a user operation on the keyboard 51 or mouse 52, the flow shown in FIG. 15 is started.

FIG. 15 is a diagram showing an outline flow of simplified annotation processing for the machine learning model model1.

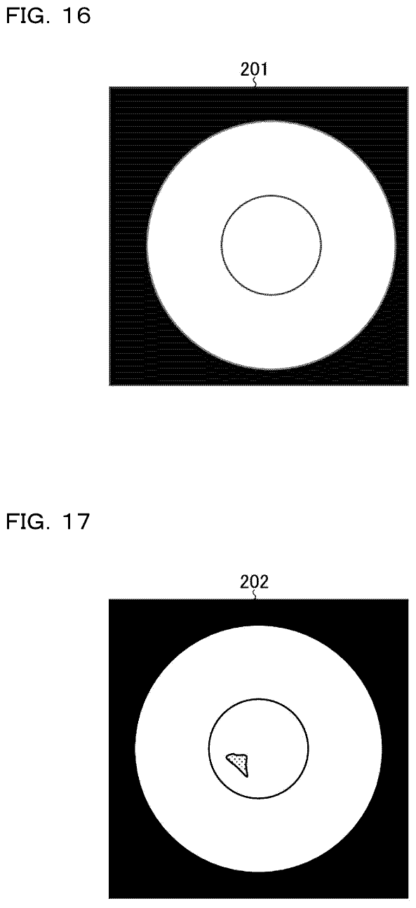

In step S21, the processor 13a accepts the non-defective product image data and the defective product image data selected by user operation. The non-defective product image data and the defective product image data selected by user operation are image data that are mutually related, that is, image data of the same type of work that has been captured. For example, the processor 13a accepts the data of the non-defective product image 201 shown in FIG. 16 and the data of the defective product image 202 shown in FIG. 17.

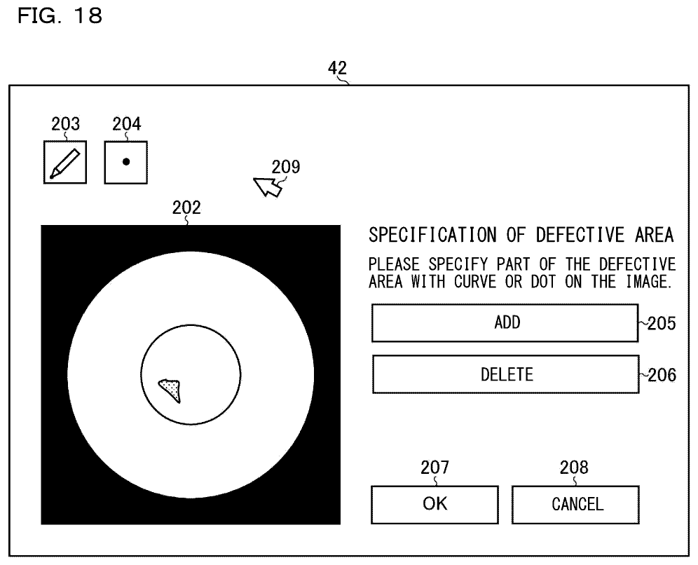

In step S22 following step S21, the processor 13a displays the defective product image 202 for simple annotation on the display device 4. At this time, as shown in FIG. 18, the display screen 42 of the display device 4 displays the defective product image 202 along with icons 203 to 204 for simple annotation processing, an add button 205, a delete button 206, an OK button 207, a cancel button 208, a pointer 209, and a message.

In step S23 following step S22, the processor 13a specifies a part of the defective area. The pointer 209 can be moved to any position on the display screen 42 by user operation with the mouse 52. When the pointer 209 overlaps with a specific icon or button, and a user click operation is performed on the mouse 52, the specific icon or button is selected. It is also possible that either icon 203 or 204 is selected by default from the beginning.

When the add button 205 is selected, it becomes possible to specify the defective area. When the delete button 206 is selected, it becomes possible to delete the mistakenly specified defective area by selecting the mistakenly specified defective area. When the OK button 207 is selected, the specification process in step S23 is completed, and the process proceeds to step S24. When the cancel button 208 is selected, the specification process in step S23 is invalidated, and without proceeding to the process of step S23, the flow shown in FIG. 15 is forcibly terminated.

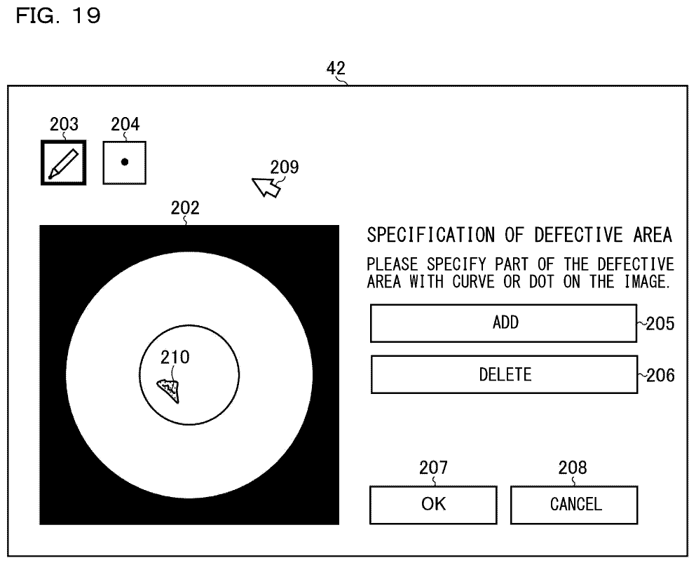

When the icon 205 is selected as shown in FIG. 19, the processor 13a specifies the defective area in the defective product image 202 with a free curve 210 formed in accordance with user operation (the user's drag operation on the mouse 52). The free curve 210 may be either a closed curve or an open curve.

An icon may be provided to specify the defective area in the defective product image 202 with a geometric curve formed in accordance with user operation, instead of or in addition to the icon 205. Similarly, an icon may be provided to specify the defective area in the defective product image 202 with a Bezier curve formed in accordance with user operation, instead of or in addition to the icon 205.

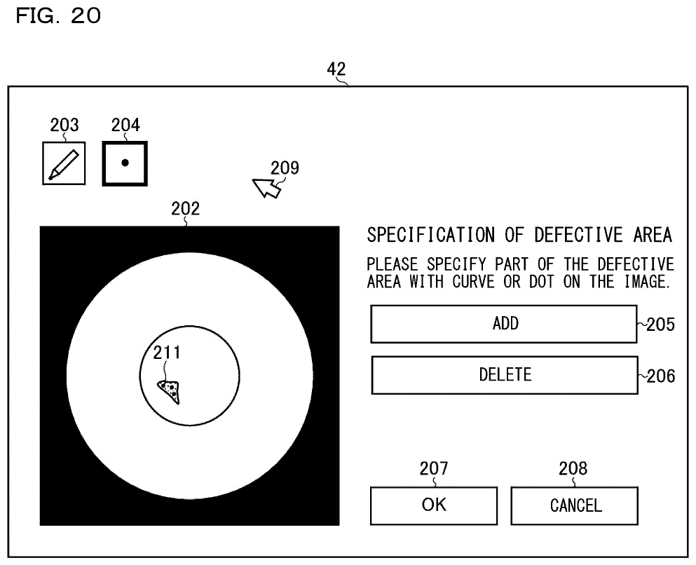

As shown in FIG. 20, when the icon 204 is selected, the processor 13a specifies the defective area in the defective product image 202 with dots 211 formed in response to user operation (user's click operation on the mouse 52).

In step S24 following step S23, processor 13a generates difference image data by taking the difference between the data of non-defective product image 201 and the data of defective product image 202. Since the position of the work, brightness, etc. do not completely match between non-defective product image 201 and defective product image 202, processor 13a may take the difference using known methods such as matching by normalized correlation.

In step S25 following step S24, the processor 13a identifies a collection of pixels in which the difference of the difference image data generated in step S24 is equal to or greater than a certain threshold value as a candidate for the anomalous region, and identifies a collection of pixels in which the difference of the difference image data generated in step S24 is less than a certain threshold value as a candidate for the background region (region other than the anomalous region).

In step S26 following step S25, processor 13a identifies the anomalous region based on the candidates for the anomalous region specified in step S24 and part of the defective area specified in step S23.

The processing content of step S26 includes, for example, the following first processing or second processing.

In the first processing, the processor 13a identifies the anomalous region based on the boundary between the candidates for the anomalous region identified in step S25 and the candidates for the background region, and a part of the defective area specified in step S23. For example, the processor 13a calculates the midpoint between each point (each pixel) constituting the boundary and the part of the defective area specified in step S23 that is closest to each of those points, calculates the midline which is a collection of those midpoints, and identifies the portion enclosed by the midline as the anomalous region. The ratio of the distance between the points constituting the boundary and the midpoints, and the distance between the points constituting the boundary and the part of the defective area specified in step S23 that is closest to those points, may be fixed, or may be arbitrarily changed by setting changes through user operation.

In the second processing, the processor 13a identifies the anomalous area based on the feature quantities of each micro region constituting the candidates for the anomalous area identified in step S25 and the feature quantities of each micro region constituting a part of the defective area specified in step S23. For example, the processor 13a extracts feature quantities similar to the feature quantities of each micro region constituting a part of the defective area specified in step S23 from the feature quantities of each micro region constituting the candidates for the anomalous area identified in step S25, and identifies the aggregate of micro regions having the extracted feature quantities as the anomalous area. The processor 13a determines the similarity of feature quantities based on the direction and magnitude of the feature quantity vector.

Whether it is the first processing or the second processing mentioned above, the processor 13a identifies an area expanded beyond a part of the defective area specified in step S23 as an anomalous region. Then, the processor 13a adds the anomalous region (teaching content) as metadata to the data of the defective product image 202 to generate training data, and stores the generated training data in the storage device 19. When the processing of step S26 is completed, the flow shown in FIG. 15 ends.

In order to specify an area expanded from a part of the defective area specified in step S23 as an anomalous region, the machine learning model model1, which was trained using the training data generated by executing the flow shown in FIG. 15, can output detection results that are closer to the actual defective area than the simple annotation (a part of the defective area specified in step S23).

### <Others>

In addition, various technical features disclosed in this specification can be modified in various ways without departing from the purport of the technical creation other than the above embodiments.

That is, the above embodiments should be considered as illustrative in all respects and not restrictive. Furthermore, the technical scope of the present invention should be understood to include all modifications that fall within the meaning and range of equivalence of the claims as defined by the patent claims.

In the above embodiment, the image inspection apparatus, which performs inspection of inspection image data using a model that can reduce the computational cost required for learning in the production site of the work, is equipped with a function that performs simplified annotation processing that does not require rough specification of areas other than the anomalous area. However, in order to realize an image inspection apparatus that can solve the problem that not only rough specification of the anomalous area is necessary in the simplified annotation processing but also rough specification of areas other than the anomalous area is required, it may be equipped with a function that performs simplified annotation processing that does not require rough specification of areas other than the anomalous area in an image inspection apparatus having U-Net, for example.

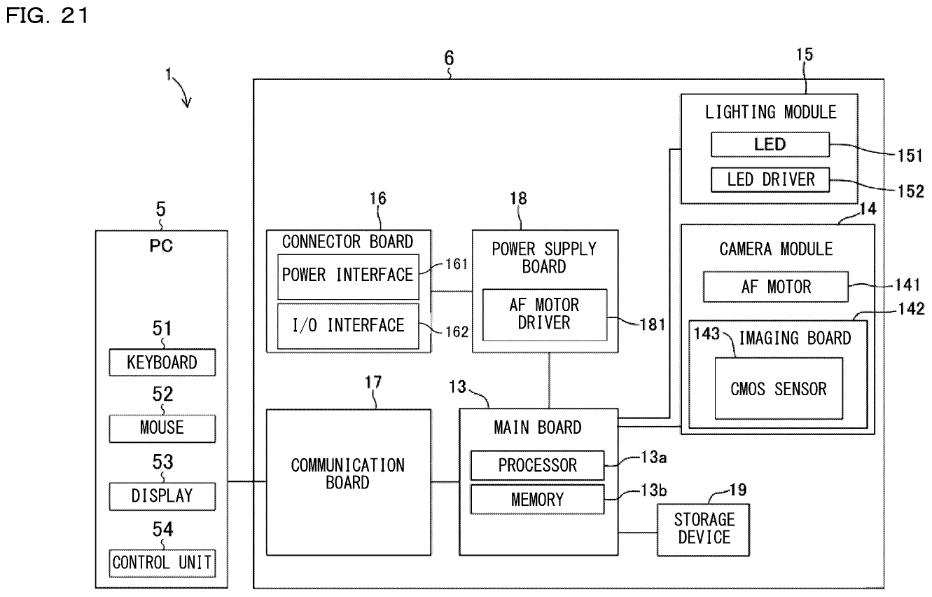

The hardware configuration of the appearance inspection apparatus 1 may be other than the configuration (controller type) shown in the above embodiment. FIG. 21 is a diagram showing another hardware configuration (smart camera type) of the appearance inspection apparatus 1. The appearance inspection apparatus 1 in this figure is equipped with a smart camera 6 instead of the previously mentioned control unit 2 and imaging unit 3. In addition, the personal computer 5 may be equipped with a display 53 in addition to the previously mentioned keyboard 51 and mouse 52. Furthermore, in this figure, the control unit 54 is explicitly shown as a component of the personal computer 5.

The personal computer 5 can be understood as an example of a UI device that is connected to the smart camera 6 and accepts user operations. For example, the personal computer 5 accepts user operations and performs the setting and operation instructions of the smart camera 6. That is, in the smart camera type appearance inspection apparatus 1, the setting function of the smart camera 6 has been transferred to the personal computer 5 from the various functions that were handled by the controller type control unit 2.

The display 53 displays the inspected image acquired by the smart camera 6 and displays a GUI for performing various settings of the smart camera 6. The inspected image can be understood as a work image on which inspection by the smart camera 6 has been performed.

The control unit 54 displays the inspected image and GUI on the display 53. In addition, the control unit 54 is capable of accepting user operations via the keyboard 51 and mouse 52. Furthermore, the control unit 54 is also equipped with the function of setting and operation instruction for the smart camera 6 according to the user's operation.

The smart camera 6 receives setting and operation instructions from the personal computer 5. The smart camera 6 integrates the previously mentioned control unit 2 and imaging unit 3. That is, the smart camera 6 is equipped with the previously mentioned main board 13, camera module 14, lighting module 15, connector board 16, communication board 17, power supply board 18, and storage device 19.

For example, the processor 13a mounted on the main board 13 functions as an inspection unit that performs inspection of the work image. The inspection of the work image may be carried out based on the setting information set according to the setting operation accepted by the personal computer 5. The setting information may be various parameters of the setting tool.

The work image inspected by processor 13a, that is, the inspected image is retained in memory 13b, but may also be written to storage device 19. Thus, memory 13b or storage device 19 functions as a storage unit for retaining the inspected image.

The internal structure of the smart camera 6 is merely illustrative. For example, the consolidation or division of the circuit board is optional.

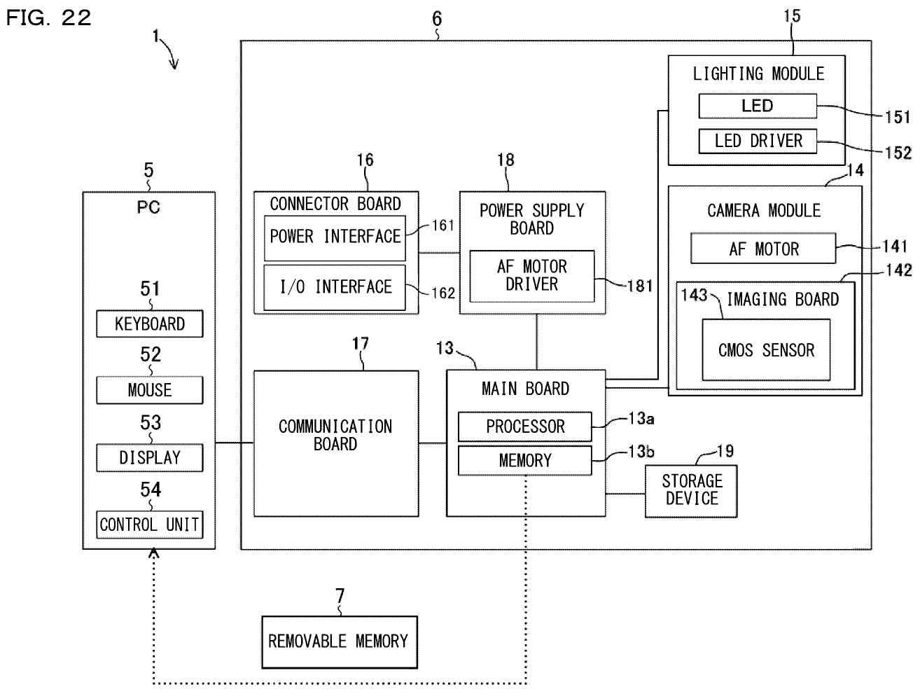

FIG. 22 is a diagram showing the usage form of the removable memory 7 in the appearance inspection apparatus 1 of the smart camera type. As shown in this figure, the memory 13b of the smart camera 6 may have the removable memory 7 detachably attached as a storage unit for storing inspected images and their inference results. The removable memory 7 can be attached and detached not only to the smart camera 6 but also to the personal computer 5. The personal computer 5 can specify the removable memory 7 attached to the smart camera 6 as the storage destination for the inspected images and their inference results. As the removable memory 7, for example, an SD memory card can be suitably used.

What is claimed is:

1. An image inspection apparatus configured to inspect inspection image data using a model in which parameters are updated by machine learning based on training image data presented by a user, the image inspection apparatus comprising:
an imaging unit;
a control unit configured to execute the model to which the inspection image data obtained by imaging by the imaging unit is input; wherein,
the model outputs image data indicating a region belonging to a first class and a region not belonging to the first class in the input inspection image data based on a label indicating the first class assigned to the training image data, so that the region belonging to the first class and the region not belonging to the first class are distinguishable, the model comprising:
an encoder part configured to extract a first feature from the inspection image data, including a plurality of intermediate layers including convolutional layers, an encoder part that extracts a first feature from the inspection image data;
a connection part configured to receive a second feature different from the first feature from at least one of the plurality of intermediate layers, convert the second feature into a third feature, and supply the third feature;
a decoder part configured to upsample the first feature extracted by the encoder part using the third feature supplied by the connection part; wherein,
the control unit updates the parameters of the connection part and the parameters of the decoder part when executing the machine learning of the model based on the training image data.

2. The image inspection apparatus described in claim 1, wherein:
the second feature has spatial information different from the first feature.

3. The image inspection apparatus described in claim 1, wherein:
the decoder part generates a fourth feature having the same size and the same number of channels as the third feature, and generates a fifth feature having the same size and the same number of channels as the third feature by adding the third feature and the fourth feature.

4. The image inspection apparatus described in claim 1, wherein:
the decoder part generates a fourth feature having the same size as the third feature, and generates a fifth feature having a larger number of channels than the third feature by concatenating the third feature and the fourth feature.

5. The image inspection apparatus described in claim 1, wherein:
the connection part receives a plurality of the second features, each having a different size.

6. The image inspection apparatus described in claim 1, further comprising:
a display unit, wherein,
the control unit generates a inspection result of the inspection image data based on the output of the model,
the display unit is configured to display the output of the model along with the inspection result of the inspection image data.

7. The image inspection apparatus described in claim 1, further comprising:
a reception unit configured to accept user operation, and
an specification unit configured to specify a region corresponding to the first class in the image based on the training image data, the boundary for the specified region is a line formed in accordance with the user operation.

8. The image inspection apparatus described in claim 7, wherein:
the line formed in accordance with the user operation is a geometric curve, Bezier curve, or free curve.

9. The image inspection apparatus described in claim 1, further comprising:
a reception unit configured to accept user operation, and
an specifying unit configured to specify a region corresponding to the first class in the image based on the training image data, the region being specified with a free-form paint image formed in accordance with the user operation.

10. An image inspection apparatus comprising:
an imaging unit;
an execution control unit configured to execute the model;
a setting control unit configured to set the model; wherein,
the model includes,
an encoder part,
a decoder part,
a connection part between the encoder part and the decoder part,
the setting control unit,
accepts a defective product image and simple annotation specifying a part of the defective area of the defective product image,
accepts a non-defective product image, and
updates the parameters of the connection part and the parameters of the decoder part based on the simple annotation and the non-defective product image,
the model with updated parameters of the connection part and the parameters of the decoder part outputs a detection result closer to the actual defective area than the simple annotation.

11. An image inspection apparatus comprising:
an imaging unit;
an execution control unit configured to execute a model;
a setting control unit that sets parameters related to the model, wherein,
the model is a model configured to segments an input image into a first region and a second region,
the setting control unit,
accepts a defective product image and a simple annotation specifying a part of the first region of the defective product image,
accepts a non-defective product image, and
updates the parameters of the model based on the simple annotation and the non-defective product image.

12. The image inspection apparatus described in claim 10, further comprising:
a reception unit configured to accept user operation, wherein,
the setting control unit accepts the simple annotation by the dots formed in accordance with the user operation with respect to the defective product image.

13. The image inspection apparatus described in claim 10, further comprising:
a reception unit configured to accept user operation, wherein,
the setting control unit accepts the simple annotation by a curve formed in accordance with the user operation with respect to the defective product image.

14. The image inspection apparatus described in claim 11, further comprising:
a reception unit configured to accept user operation, wherein,
the setting control unit accepts the simple annotation by the dots formed in accordance with the user operation with respect to the defective product image.

15. The image inspection apparatus described in claim 11, further comprising:
a reception unit configured to accept user operation, wherein,
the setting control unit accepts the simple annotation by a curve formed in accordance with the user operation with respect to the defective product image.
